(19) United States
(12) Patent Application Publication
(10) Pub. No.: US 2025/0137587 A1
(43) Pub. Date: May 1, 2025

(54) CARTRIDGE TANK

(71) Applicant: TOYOTA JIDOSHA KABUSHIKI KAISHA, Toyota-shi Aichi-ken (JP)

(72) Inventor: Tomoki NAKASHIMA, Nagoya-shi Aichi-ken (JP)

(73) Assignee: TOYOTA JIDOSHA KABUSHIKI KAISHA, Toyota-shi Aichi-ken (JP)

(21) Appl. No.: 18/892,680

(22) Filed: Sep. 23, 2024

(30) Foreign Application Priority Data
Oct. 25, 2023 (JP) 2023-183191

(51) Int. Cl. F17C 1/12

(52) U.S. Cl. CPC F17C 1/12; F17C 2201/0109; F17C 2201/058; F17C 2203/0329; F17C 2221/012; F17C 2223/036

(57) ABSTRACT

A cartridge tank provided with a heat insulating material layer that can be disposed on an outer periphery of the tank without necessarily using an adhesive, and can also correspond to variations in dimensions of the tank. The outer surface of the tank body is provided with a heat insulating material layer, the heat insulating material layer has a sheet material made of a heat insulating material, the sheet material is formed in a cylindrical shape, the sheet material at the end portion in the axial direction of the tank body, extending in the axial direction of the cylindrical, by a plurality of notches arranged in the circumferential direction is formed, a plurality of small pieces arranged in the circumferential direction are provided, the cylindrical opening is narrowed by the end portions of the small pieces adjacent overlap.

### CROSS-REFERENCE TO RELATED APPLICATIONS

This application is based upon and claims the benefit of priority of the prior Japanese Patent Application No. 2023-183191, filed on Oct. 25, 2023, the entire contents of which are incorporated herein by reference.

### FIELD

The present disclosure relates to a cartridge tank.

### BACKGROUND

Patent Document 1 discloses a tank for storing gas, wherein a heat storage material layer is provided on the outer surface of the tank body, and an impact recording layer is provided on the outer surface of the heat storage material layer. The shock recording layer is provided on the outermost layer of the tank, and consists of a heat insulating material layer having a heat insulating function capable of retaining deformation due to impact and recordable.

### CITATION LIST

### Patent Literature

Patent Literature 1: JP 2008-291906 A

### SUMMARY

### Technical Problem

However, particularly in a relatively small tank it is necessary to place the heat insulating material over the entire tank periphery, when pasting the heat insulating material to the entire tank periphery, or workability is deteriorated when the pasting by the adhesive material, the total length and outer diameter of the tank it is difficult to paste the heat insulating material successfully due to variations.

In view of the above problems, in the present disclosure, there is provided a cartridge tank provided with a heat insulating material layer which can be arranged on an outer periphery of a tank without necessarily using an adhesive, and which can cope with variations in the dimensions of the tank.

### Solution to Problem

The present application discloses a cartridge tank which is detachable with respect to equipment, wherein a heat insulating material layer is provided on an outer surface of the tank body, the heat insulating material layer has a sheet material made of a heat insulating material, the sheet material is formed in a cylindrical shape, the sheet material at an end portion of the tank body in the axial direction extends in the cylindrical axial direction, by a plurality of notches arranged in the circumferential direction are formed, a plurality of small pieces arranged in the circumferential direction are provided, and the cylindrical opening is narrowed by the end portions of adjacent small pieces overlap each other.

When three pieces arranged in sequence adjacent to one direction in the circumferential direction are a first piece, a second piece, and a third piece, the second piece can be configured to overlap the first piece so as to enter the lower side of the first piece, and to overlap the third piece so as to enter the upper side of the third piece.

A hole is provided in the small piece, and a plurality of small pieces may be fastened by passing a string-like fastening material through a hole of a plurality of small pieces.

### Effects

According to the present disclosure, by overlapping the end portions of the plurality of small pieces formed by the notches, it is possible to cope with the outer diameter variation or the like of the tank body, and it is possible to fix the heat insulating material to the tank even if an adhesive is not necessarily used, thereby improving the workability.

### BRIEF DESCRIPTION OF DRAWINGS

FIG. 1A is a diagram showing the configuration of the cartridge tank 10.

FIG. 1B is another diagram showing the configuration of the cartridge tank 10.

FIG. 2 is an external perspective view showing the periphery of a part corresponding to the side-end 12b of the tank body 11.

FIG. 3A is a diagram illustrating an embodiment of the sheet material 15.

FIG. 3B is another diagram illustrating an embodiment of the sheet material 15.

### DESCRIPTION OF EMBODIMENTS

### 1. Cartridge Tank

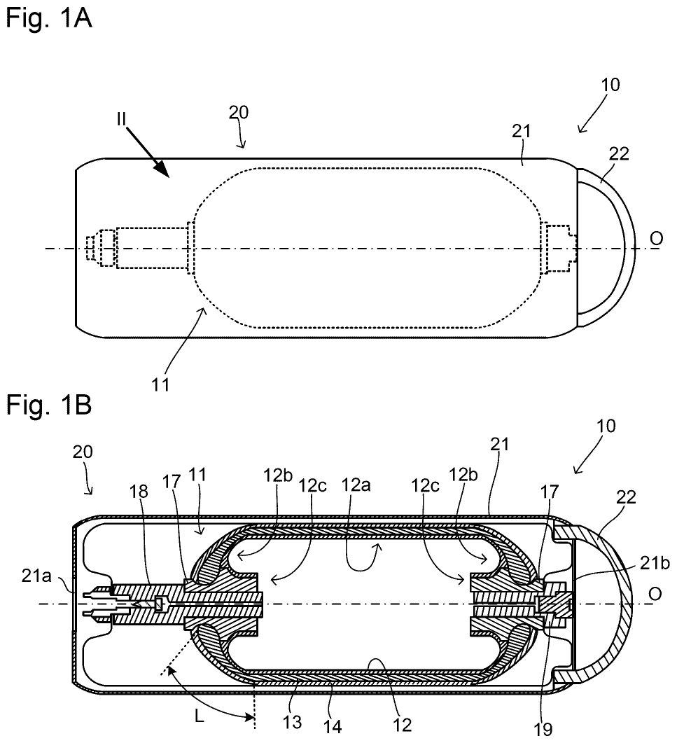

The cartridge tank 10 is a member including a container for storing a fluid which becomes a fuel (hydrogen in this form) in a liquid state or a gaseous state. FIGS. 1A and 1B show diagrams for illustration. FIG. 1A is an external view of a cartridge tank 10 (the enclosed tank body 11 is represented by a dotted line.), FIG. 1B is a cross-sectional view of the cartridge tank 10 along the axis O of the tank body 11. As can be seen from these figures, the cartridge tank 10 in this form has a tank body 11 and a case 20

Further, the tank body 11 includes a liner 12 constituting the container portion, the reinforcing layer 13, and a heat insulating material layer 14, further cap 17, on-off valve 18, and has a plug 19.

### 1.1. Liner

The liner 12 is a hollow member which partitions an internal space of a container portion in the tank body 11, and is cylindrical in this form. Liner 12, the opening at both ends of the fuselage portion 12a whose diameter is substantially constant is narrowed by the dome-shaped side-end 12b, the mouthpiece 17 is disposed in the narrowed opening 12c.

It is sufficient that the liner 12 is made of a material capable of retaining (e.g., hydrogen) contained in its internal space without leaking, and a known material can be used as the material. Specifically, for example, a nylon resin, a polyethylene-based synthetic resin, or made of a metal such as stainless steel or aluminum. In some embodiments, the material constituting the liner is a synthetic resin from the viewpoint of weight reduction of the tank.

The thickness of the liner 12 is not particularly limited, but is 0.5 mm-3.0 mm.

### 1.2. Reinforcement Layer

The reinforcing layer 13 is one of the members constituting the container portion, and a fiber is laminated over a plurality of layers on the outer periphery of the liner 12, and a cured resin is impregnated into the fiber. While ensuring the strength against the inner pressure of the liner 12 by 13 to the reinforcing layer, the fire resistance performance is enhanced.

A layer made of fibers is formed by winding a fiber bundle over a plurality of layers to a predetermined thickness on an outer periphery of a liner 12. Although the thickness of the reinforcing layer 13 and the number of turns of the fiber bundle are determined by the required strength, they are not particularly limited, but are of a 10 mm-30 mm degree. In particular, in the portable cartridge tank (cartridge tank on the assumption of carrying), since the outer diameter is small relative to the fixed hydrogen tank to be mounted on an automobile, from the viewpoint of securing strength tends to reduce the number of laminated reinforcing layers (i.e., the reinforcing layer becomes thinner), on the other hand, fire resistance performance tends to decrease. Therefore, particularly in the portable cartridge tank, it is possible to effectively increase the fire resistance performance by placing the heat insulating material layer over the entire outer periphery of the container portion as described later.

### <Fiber Bundle>

For example, carbon fibers are used for the fiber bundle of the reinforcing layer 13, and the fiber bundle has a band shape in which carbon fibers form a bundle and have a predetermined cross-sectional shape (e.g., a rectangular cross section), Although not particularly limited, there may be mentioned a rectangular shape having a 6 mm-20 mm cross section and a 0.1 mm-0.3 mm thickness. The amount of carbon fibers contained in the fiber bundle is not particularly limited, and examples thereof include a carbon fiber of about 36000.

### <Impregnated Resin>

The resin impregnated and cured in the fiber (fiber bundle) in the reinforcing layer 13 is not particularly limited as long as it can increase the strength of the fiber by this. Examples thereof include a thermosetting resin which is cured by heat, and specific examples thereof include an amine-based or anhydride-based curing accelerator and an epoxy resin containing a rubber-based reinforcing agent, an unsaturated polyester resin, and the like. In addition, a resin composition containing an epoxy resin as a main agent and cured by mixing a curing agent thereto can be also mentioned. According to this, it is automatically cured by allowing the resin composition which is the mixture to reach and penetrate the fiber layer between the time when the main agent and the curing agent are mixed and cured.

### 1.3. Insulation Layer

Insulation layer 14 is disposed so as to cover the outer periphery of the reinforcing layer 13, a layer disposed so as to form the outermost layer of the container portion of the tank body 11. Insulation layer 14 is a member made of a sheet-like heat insulating material is provided so as to be wound around the reinforcing layer 13. This enhances the fire resistance performance of the tank body 11. The material constituting the heat insulating material is not particularly limited as long as it has heat insulating property, and examples thereof include expanded graphite. Expanded graphite exhibits sufficient fireproof performance by expansion when it reaches above a certain temperature.

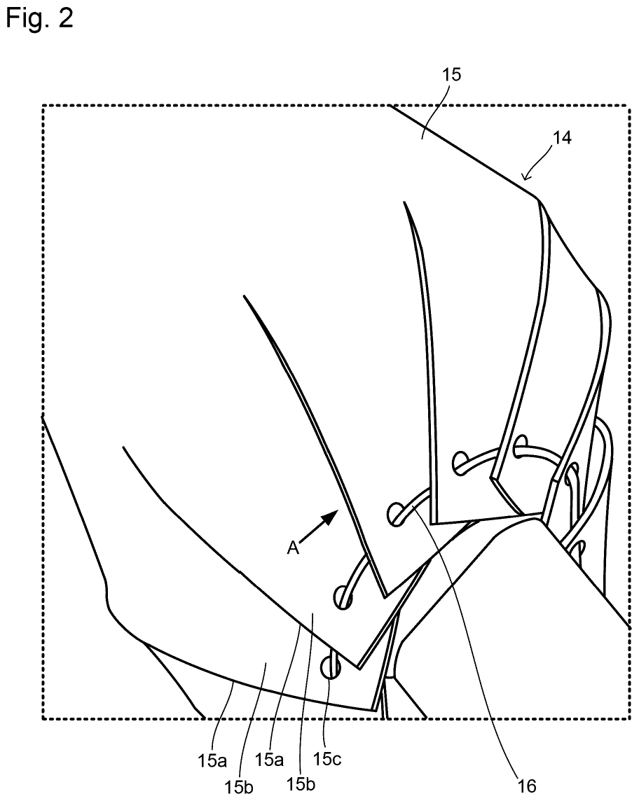

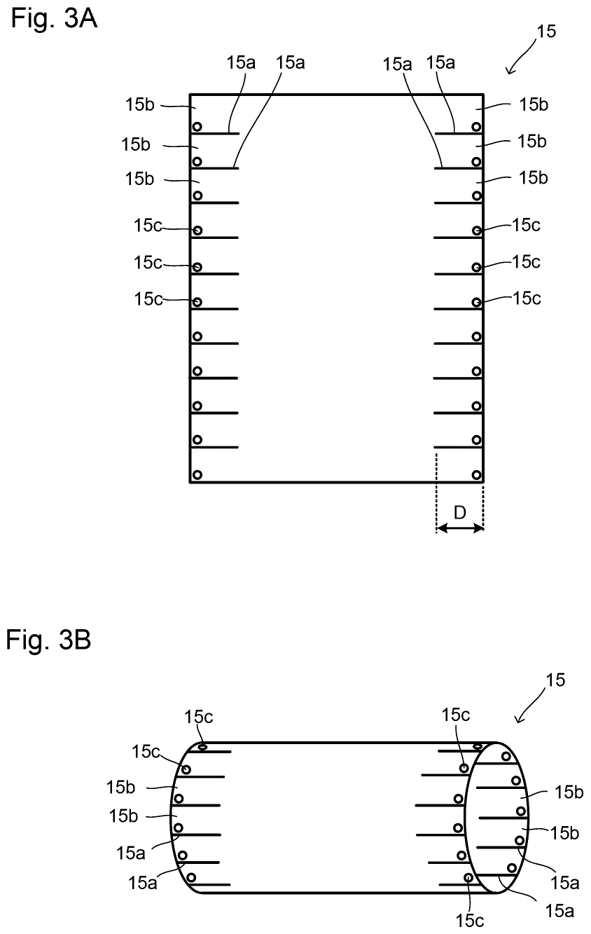

Although the heat insulating material layer 14 as described above is disposed so as to cover the outer periphery of the reinforcing layer 13, the heat insulating material layer 14 is not only the outer side of the fuselage portion 12a, the outer side of the side end 12b the diameter is gradually reduced continuously (in one sheet-like heat insulating material) are arranged wound. Therefore, in this form, a portion of the heat insulating material layer 14 which is disposed on the outer side of the side end portion 12b is described below. FIGS. 2, 3A, and 3B showed the figure for an explanation. FIG. 2 is a view of the tank main body 11 viewed from II of the arrow in FIG. 1A, and is a view viewed from the outer side of one side end 12b. The outer side of the other side-end 12b can be considered as well. FIGS. 3A and 3B are diagrams for further explaining the heat insulating material layer 14, FIG. 3A is a condition in which the sheet material 15 constituting the heat insulating material layer 14 is widened, FIG. 3B the sheet material 15 is a cylindrical respectively schematically represents a state.

As can be seen from FIGS. 2, 3A and 3B, the heat insulating material layer 14 is configured to have a sheet material 15 and a fastening material 16.

### <Form of Sheet Materials and Fastening Materials>

The sheet material 15 is a sheet-like member made of a heat insulating material such as expanded graphite or the like as described above. Sheet material 15 is a rectangular sheet in a condition of being widened as can be seen from FIG. 3A, the notch 15a extending in a direction toward each other two sides opposite to each other among the four sides are provided a plurality in a direction along the side (FIG. 2, the sign of the notch 15a in FIGS. 3A and 3B is attached only to a part of the notch for ease of view. Hereinafter, the same applies to other parts.).

Thus, a plurality of small piece 15b cut across the cut 15a is aligned along the side form.

The depth of the cut 15a shown in D in FIG. 3A is not limited, but in some embodiments is as long as the length (path) along the curvature in the cross section of the reinforcing layers 13 arranged in the side end 12b shown in L in FIG. 1B. Thus, it is easy to appropriately place the seat material 15 on the outer side of the side end 12b.

In addition, a hole 15c is provided on each small piece 15b of the sheet material 15 Sheet material 15 is stably held on the outer periphery of the reinforcing layer 13 by tightening through the cord-shaped fastening member 16 to the hole 15c as described later. For example, a metal wire such as an insulin lock can be used as the fastening material 16.

### <Arrangement and Mode of Sheet Material>

More specifically, for example, the sheet material 15 is disposed on the outer periphery of the reinforcing layer 13 in the following manner and is held as the heat insulating material layer 14.

Sheet material 15 which is widened as shown in FIG. 3A, the end portions of the sides notched 15a is not provided as shown in FIG. 3B is a cylindrical shape so as to overlap. The overlapped ends are fixed by stables, adhesives, or the like to maintain a tubular shape. Therefore, at both axial ends of the cylinder, the cut 15a and the small piece 15b (including the bore 15c) in the circumferential direction are alternately arranged. The diameter of the cylinder is substantially the same as the diameter of the outer periphery of the reinforcement layer 13 disposed on the body portion 12a (or slightly larger).

Then, the liner 12 in which the reinforcing layer 13 is disposed inside the cylinder (inside the cylinder) formed by the sheet material 15 is inserted (the mouthpiece 17 is already disposed in the liner 12) At this time the cut 15a and small piece 15b is disposed so that the outer portion of the side end portion 12b is substantially the same position.

A cut 15a and a small piece 15b are formed in the part of the sheet material 15 arranged on the outer side of the side end 12b Therefore, as can be seen from FIG. 2, the sheet material 15 along the shape of the side end 12b by the opening of the cylinder by the sheet material 15 are sequentially superimposed end portions of the small 15b adjacent is narrowed is disposed on the outer periphery of the reinforcing layer 13. Then, by fastening through the string-like fastening material 16 to the hole 15c, to retain its shape.

Although there is no particular limitation on the way in which the end portions of the adjacent small piece 15b overlap each other, they can be arranged so as to be sequentially overlapped so that the adjacent small piece 15b are upward in one direction in the circumferential direction of the cylinder by the sheet material 15. In other words, when considering the first small piece, the second small piece, and the third small piece which are 3 small piece 15a aligned along one direction of the circumferential direction, the second small piece is overlapped with the first small piece so as to enter the lower side of the first small piece (reinforcing layer side), and the second small piece is overlapped so as to be the upper side of the third small piece (opposite to the reinforcing layer side) to form a purse string bag shape.

### <Effect, Etc.>

By configuring the heat insulating material layer 14 in this way, it is possible to appropriately arrange the heat insulating material layer 14 can absorb the variation or the like of the outer diameter and the total length of the tank body 11 by adjusting the degree of overlap of the small 15b on the outer side of the side-end 12b.

Further, according to the heat insulating material layer 14 of the present embodiment, it is possible to fix the heat insulating material (sheet material 15) along the reinforcing layer 13 without using an adhesive, and thus it is possible to improve workability. However, fixing using an adhesive is not necessarily excluded, and it is also possible to use an adhesive in combination, and at that time, there is an aspect in that the amount of the adhesive used and the site of use can be reduced, and the like.

Furthermore, at the site of the heat insulating material layer 14 disposed on the outer side of the side-end 12b, since the end portions of the small piece 15b overlap each other, the gap is hardly formed, to prevent the direct flame from entering, it is possible to increase the fire resistance. Although there is a possibility that a gap is slightly formed between the small piece 15b of the sheet material 15 in the direction shown by A in FIG. 2, the heat insulating material to form a sheet material has a property that generally swell when subjected to heat (expands), the gap also filled slightly had by the expansion, direct flame is more reliably prevented from entering. Especially by using expanded graphite in the sheet material 15, the effect becomes remarkable.

### 1.4. Base, On-Off Valve, Plug

Mouthpiece 17 is a member which is attached to each of the two opening 12c of the liner 12, is disposed at each of the axial O-direction opposite ends of the liner 12, the valve is disposed with functions as an opening communicating the inside and outside of the container part. On-off valve 18 to one of the cap 17, the molten plug 19 is disposed on the other cap 17.

The material constituting the base 17 is not particularly limited as long as it has the necessary strength, and examples thereof include stainless steel, aluminum, copper, and iron.

The on-off valve 18 is a so-called check valve, on-off valve, is closed when the cartridge tank 10 is not mounted to the device to be used, it is opened by being pressed by, for example, a push rod when mounting to the device.

The plug 19 is a safety valve for releasing gas (hydrogen) in the tank by opening the plug when reaching a predetermined temperature, also called a fusible alloy safety valve. A specific embodiment of the fusing plug 19 is not particularly limited, and a known one can be used.

In this embodiment, the opening/closing valve 18 and the melting stopper 19 are arranged in different mouthpieces 17, respectively, and are provided so as to be opposite to each other at one end side and the other end side of the tank body 11, but the present disclosure is not necessarily limited to such a form, and both valves may be arranged in the same mouthpiece.

### 1.5. Case

Case 20 is a member that contains the tank body 11 to form the outer shell of the cartridge tank 10, and has a housing 21, a handle 22.

Housing 21 is a cylindrical member, and is configured to be able to store the tank body 11 inside thereof. The opening and closing valve 18 of the tank body 11 housed in the housing 21, respectively hole 21a in the position where the molten plug 19 is opposed, hole 21b is provided, accessing the opening and closing valve 18 from the outside, sprayed from the plug 19. It is configured to be able to discharge the hydrogen to the outside.

The handle 22 is an arcuate member disposed at an end of the housing 21 opposite to the opening/closing valve 18 side, and the user can carry the cartridge tank 10 by holding the handle 22 and perform attaching/detaching operations of the cartridge tank 10 to/from device using the cartridge tank 10.

### 1.6. Other

The allowable pressure of the tank 51 is not particularly limited, but may include a tank capable of storing hydrogen at an allowable pressure of 70 MPa or less beyond 20 MPa from the viewpoint of supplying more hydrogen.

### REFERENCE SIGNS LIST

10 . . . . Cartridge tank, 11 . . . tank body, 12 . . . liner, 13 . . . reinforcement layer, 14 . . . insulation layer, 15 . . . sheet-material, 15b . . . pieces, 17 . . . mouthpiece, 18 . . . on-off valve, 19 . . . plug, 20 . . . case

What is claimed is:

1. A cartridge tank attachable to and removable from an apparatus, the cartridge tank comprising:
a tank body; and
a heat insulating material layer provided on an outer surface of the tank body, wherein
the heat insulating material layer comprises a sheet member made from a heat insulating material, and is formed by forming the sheet member into a tubular shape,
a plurality of notches that extend in an axial direction of the tubular shape and align in a circumferential direction are formed at ends of the tank body in the axial direction, and thereby, the sheet member includes a plurality of small pieces that align in the circumferential direction, and
ends of each adjacent ones of the small pieces overlap each other, and thereby, openings of the tubular shape narrow.

2. The cartridge tank according to claim 1, wherein when three of the small pieces which are adjacent to each other and align in order in one direction in the circumferential direction are defined as a first small piece, a second small piece, and a third small piece, the second small piece overlaps the first small piece in such a manner that the second small piece comes underneath the first small piece, and overlaps the third small piece in such a manner that the second small piece comes onto the third small piece.

3. The cartridge tank according to claim 1, wherein
the small pieces are provided with holes, and
a plurality of the small pieces are fastened by passing a string-like fastening member through the holes of the small pieces.
